(19) United States
(12) Patent Application Publication
(10) Pub. No.: US 2009/0095436 A1
(43) Pub. Date: Apr. 16, 2009

(54) Composite Casting Method of Wear-Resistant Abrasive Fluid Handling Components

(76) Inventors: Jean-Louis Pessin, Houston, TX (US); Laurent Coquilleau, Houston, TX (US); Josh Rayner, Houston, TX (US); Anthony L. Collins, Houston, TX (US); Michael Woodmansee, Houston, TX (US)

Correspondence Address: SCHLUMBERGER TECHNOLOGY CORPORATION;David Cate, IP DEPT., WELL STIMULATION, 110 SCHLUMBERGER DRIVE, MD1, SUGAR LAND, TX, 77478, US

(21) Appl. No.: 12/175,944

(22) Filed: Jul. 18, 2008

Related U.S. Application Data
(60) Provisional application No. 60/979,233, filed on Oct. 11, 2007.

(51) Int. Cl. B22D 25/08; B32B 15/01; F04B 17/00

(52) U.S. Cl. 164/95; 428/577; 417/366

(57) ABSTRACT

A method of manufacturing composite parts for an apparatus handling abrasive fluids and an apparatus for handling abrasive slurries, for example, a centrifugal pump. Portions of the composite parts are cast in a two-stage process. Portions to be machined are cast in a material suitable for machining and portions exposed to abrasive slurries are cast in a material that is wear-resistant.

### CROSS-REFERENCE TO RELATED APPLICATIONS

This application claims the benefit of priority from U.S. Provisional Application No. 60/979,233, filed on Oct. 11, 2007, the entire contents of which are hereby specifically incorporated by reference.

### TECHNICAL FIELD

Embodiments of the present invention relates to manufacturing of devices that have at least two conflicting but desirable manufacturing requirements, more particularly, to devices that are both wear-resistant and readily machinable by using a multi-stage casting process in which wear-resistant portions of a machine are cast in one stage and portions to be machined are cast in another stage.

### BACKGROUND OF THE INVENTION

The statements in this section merely provide background information related to the present disclosure and may not constitute prior art.

It is often the case that in manufacturing equipment, in selecting manufacturing materials and fabrication methods, trade-offs are made between properties that unfortunately are, to an extent, mutually exclusive and mutually desirable. Such trade-offs include choosing between durability and the ease of manufacturing the part, and between durability and cost.

Manufacturing of centrifugal pumps used for low-pressure pumping of abrasive slurries is a prime example where material selection tends to favor one desirable property, e.g., durability, over another, e.g., ease of manufacture or product yield. Centrifugal pumps are used in a number of industries (e.g., mining, chemical processing, industrial waste) for pumping abrasive slurries in applications where pump reliability is of critical importance. One example application of centrifugal pumps is their use in the oil industry for mixing and pumping cement. Thus, the fluid end components of centrifugal pumps may be cast from metals with superior hardness in order to improve the pump's overall wear-resistance. Still, pumps must be connected to pipes and motors. In order to provide good surfaces for these connections, the pump parts are typically machined. However, hard metals, while possessing superior wear-resistance, are prone to fracturing during the final machining stages of part manufacture. Therefore, a trade-off exists between selecting a metal that has a high hardness to improve the fluid end wear-resistance and selecting a metal with a high fracture toughness to make the machining process more economical.

After drilling a well, such as an oil or gas well, a casing is commonly lowered into the wellbore. Cement slurry is then pumped downhole through the casing and back up into the annulus between the casing and the borehole. Upon setting, the slurry forms a cement sheath that holds the casing in place, thereby providing stability and protection. In addition, the cement sheath provides zonal isolation. It is thus critical to prevent upward fluid flow, such as gas migration or water flows, through and along the cement sheath and to prevent exchange between and among formation layers through which the wellbore passes. It is common to use centrifugal pumps for mixing and low-pressure pumping of the cement slurry at the well site.

The reliability of all pieces of machinery used at an oil or gas well is crucial for several reasons, a major one being that the cost of shutting down operations for repair and replacement of defective equipment is typically very high. The centrifugal pumps used in mixing and pumping cement slurries for cementing operations are an example of equipment where reliability is critical.

The components of centrifugal pumps used for the abrasive slurries used in the oil-field, i.e., centrifugal pump parts wherein abrasion resistance and/or wear resistance is sought in the final product, are sometimes manufactured as white iron castings, which obtain a high level of wear resistance from a surface carbide formed by significant chromium alloying. These white iron castings are manufactured in massive sand castings where a high cooling rate is not required.

However, an unfortunate side effect of the white iron castings is that while the parts manufactured in white iron are advantageously erosion resistant, they are also disadvantageously susceptible to fracturing. Susceptibility to fracturing is a significant problem with respect to many manufactured parts. For example, centrifugal pump components have portions that must be machined (e.g., flanges, boreholes and mating surfaces). Machining a part that has susceptibility to fracturing increases manufacturing costs because special machinery may be required and a lower yield can be expected because of breakage due to fracturing during machining operations, requiring the manufacturer to elevate the price-per-part to compensate for the marginal process yield.

In summary, many manufactured parts have portions that have conflicting sought-after properties. One example are parts of centrifugal pumps that both require resistance to wear from abrasive slurries and that require machining. Unfortunately, wear-resistance is in conflict with machinability because wear-resistant materials are often prone to fracturing during machining.

From the foregoing it will be apparent that there remains a need to provide a methodology for manufacturing parts, for example, components of centrifugal pumps, which have conflicting properties for different portions of a part. A notable example are parts of centrifugal pumps that have portions that are exposed to wear due to exposure to abrasive slurries and, in contrast, portions that are readily machinable to fine tolerances for the purpose of mating to other parts.

### SUMMARY

A composite part is manufactured such that different portions of the composite part have different material properties depending on the material properties that are desirable for each such different portion without suffering from negative material properties that may be associated with materials that are used for obtaining properties that are desirable for other non-coincident portions of the part. For example, a centrifugal pump manufactured according to embodiments of the invention has portions that are readily machined and portions that are very wear-resistant in an economical manner in which the product yield is high.

A composite component of an apparatus for handling abrasive fluids and that has portions that are machined and portions that are wear-resistant is cast in a two-stage process in which one stage includes casting portions to be machined in a first material and casting wear-resistant portions in a second material. Thus, such a part, which may be a part of a centrifugal pump, has a first portion cast from a material suitable for machining and machined to mate with other components of an apparatus for handling abrasive fluids; and has a second portion cast from an wear-resistant material and located on the component in a location exposed to abrasive fluids when the component is assembled into an apparatus for handling abrasive fluids and connected to the first portion through an interface formed by casting the second portion onto the first portion.

Embodiments of the manufacturing process may also include one or more steps, such as a solidifying step in which the first material is solidified, a heat-treating step to harden the part, in particular the portions of the part that are wear-resistant, and a machining step to produce mating surfaces.

In one embodiment the first material is mild steel. Alternatively, the first material is, for example, carbon steel with a carbon content of no more than about 0.3%, aluminum, brass, or a material with a machinability index at least equal to carbon steel with a carbon content of about 0.3%. The second material may be white iron or a material with a Brinell hardness number of at least about 400. In one embodiment the first material has a fracture toughness that is greater than the fracture toughness of the second material. In one embodiment the second material has a hardness that is greater than the hardness of the first material.

In some embodiments of the invention the melting point of the first material is higher than the melting point of the second material. In other embodiments, the heat content of the second material is such as to melt a portion of the first material thereby producing interface alloying between the portions that are to have a first property, e.g., machinability, and the portions that are to have a second property, e.g., wear-resistance.

In an embodiment, the composite part is a part of a centrifugal pump used for pumping and mixing cement slurries for oil-field operations.

Other aspects and advantages of the herein described process for manufacturing composite parts and such composite parts will become apparent from the following detailed description, taken in conjunction with the accompanying drawings, illustrating by way of example the principles of the invention.

### BRIEF DESCRIPTION OF THE DRAWINGS

FIG. 1 is a high level schematic illustration of a cement mixing and pumping operation as may be encountered at a well site where cement is pumped into the casing set in a well for the purpose of fixing casing in a borehole and isolating particular subterranean zones from other subterranean zones.

FIG. 2 is a cross-sectional view of a centrifugal pump, used herein for illustrative purposes as a non-limiting example.

FIG. 3 is an exterior side view of the centrifugal pump of FIG. 2.

FIG. 4 is a work-flow diagram illustrating the manufacturing method for producing a composite part having portions manufactured in a wear-resistant material and portions manufactured in machinable material.

FIGS. 5(a) through 5(d) are a series of cross-sectional views of a mold for casting a volute body of the centrifugal pump of FIGS. 2 and 3, and illustrating the two stages of casting the volute body.

FIG. 6 is a cross-sectional view of a centrifugal pump having composite parts manufactured such that portions that are to be machined are made from an easily machinable material and portions that are exposed to abrasive slurry are made from a wear-resistant material.

### DETAILED DESCRIPTION OF THE INVENTION

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the spirit and scope of the invention. In addition, it is to be understood that the location or arrangement of individual elements within each disclosed embodiment may be modified without departing from the spirit and scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

It should also be noted that in the development of any such actual embodiment, numerous decisions specific to circumstance must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

Disclosed herein is a manufacturing method of parts that have conflicting properties that can benefit from the properties associated with different materials, for example, manufacturing of components of centrifugal pumps that have portions that are prone to wear due to exposure to abrasive slurries and also portions that are machined to fine tolerances for the purpose of mating with other parts. In such a manufacturing process the portions that benefit from a first property are cast in a first material before the portions that benefit from the second property are cast in a second material thereby having the portions that benefit from the first property having the properties associated with the first material and portions that benefit from the second property having the properties associated with the second material.

Further disclosed herein are parts that are manufactured according to the above-described two-stage manufacturing process.

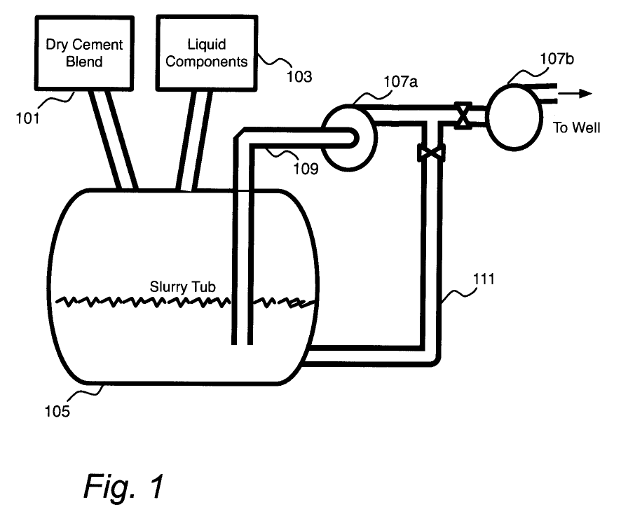

Centrifugal pumps used for mixing and pumping abrasive slurries used in oil-field operations are discussed herein for purposes of example of components that benefit from a two-stage casting manufacturing process. FIG. 1 is a high level schematic illustration of a cement mixing and pumping operation as may be encountered at a well site where cement is pumped into the casing set in a well for the purpose of fixing casing in a borehole and isolating particular subterranean zones from other subterranean zones.

The most common material used for cementing operations is a dry blend of Portland cement and powder additives which is typically transported to a well site in a dry form and mixed with certain dry additives to form a dry cement blend 101. The dry cement blend 101 is hydrated with liquid components 103, typically water and some liquid additives, in a slurry tub 105.

The dry cement blend 101 and the liquid components 103 are mixed by circulating the slurry by suctioning the slurry from the slurry tub 105 by a first centrifugal pump 107a through a suction pipe 109 and a tub recirculating line 111. A second centrifugal pump 107b pumps the mixed cement slurry to a cementing unit (not shown) at the well.

The cement slurry is a mixture of at least, for example, Portland cement and water and may contain a substantial amount of various additives, including silica, barite, calcium chloride, sodium chloride that improve the properties of the cement slurry and/or the hardened cement. Some slurry properties of interest include viscosity, density, fluid loss, hardening time and foaming tendency, among others. Some hardened cement properties of interest include hardness, gas permeability, heat tolerance and elasticity, among others. It must be appreciated that the Portland cement and many of the blend additives, which range in particle diameter from a few microns to hundreds of microns, is quite abrasive in nature.

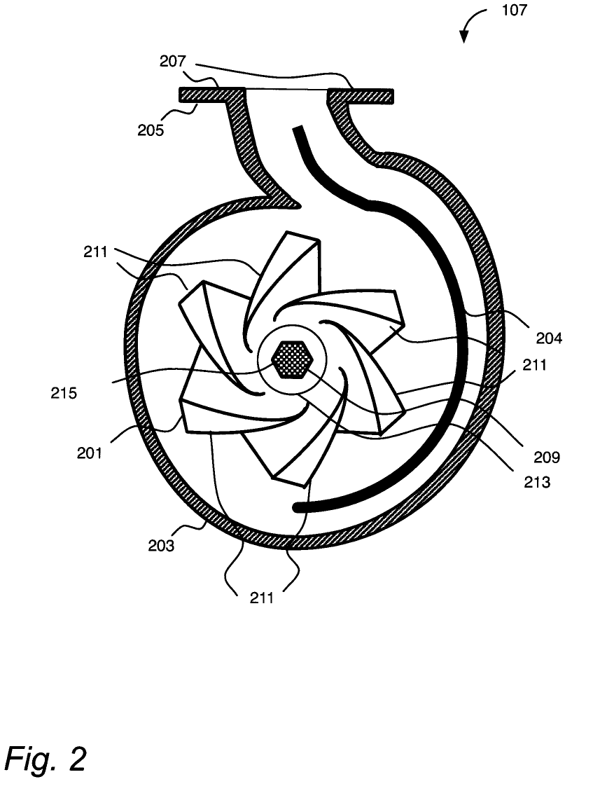

FIG. 2 is a cross-sectional view of a centrifugal pump 107, used herein for illustrative purposes as a non-limiting example. The centrifugal pump 107 consists of a shaft-mounted impeller 201 and a double-discharge volute 203. The discharge 203 is divided by a divider plate 204. The impeller 201 is mounted on a shaft 215 that is driven by an external motor. The impeller 201 is formed from a number of vanes 211.

The centrifugal pump 107 may be connected to an output pipe (e.g., the recirculating pipe 111 of FIG. 1) using the connector flange 205.

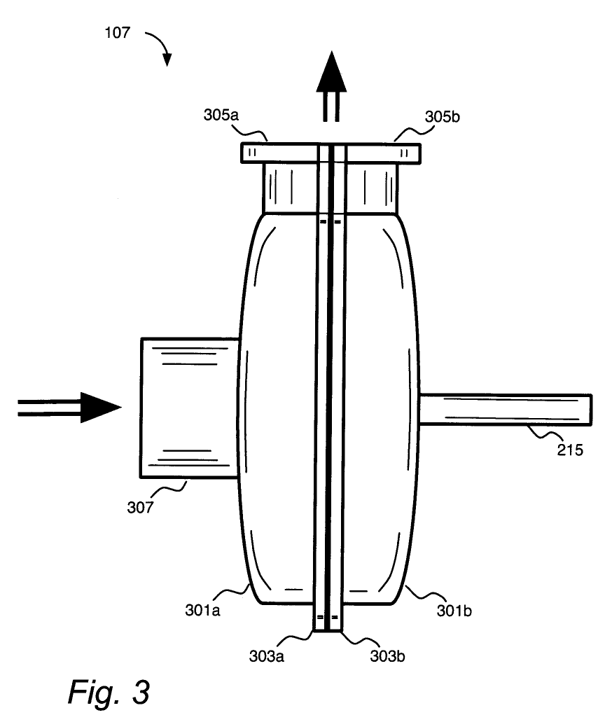

FIG. 3 is an exterior side view of the centrifugal pump 107. The volute 203 is formed from a rear volute body portion 301b and a front volute body portion 301a. The volute body portions are mated to one another using mating flanges 303a and 303b, respectively, located on each volute body 301. The connector flange 205 is formed from connector flanges 305a and 305b, respectively, located on each volute body portion 301.

The impeller 201 is driven by an input shaft 205, which in turn is driven by a motor (not shown).

Cement slurry input, for example from the suction pipe 109, is input at a pipe 307 and enters the centrifugal pump 107 near the axis of the impeller 201, and the cement slurry output discharges through an opening formed by the connector flanges 305a and 305b.

Returning now to FIG. 2, rotation of the impeller 201 causes a pumping action of the cement slurry as it is accelerated outwards along the impeller vanes 211.

In FIGS. 2 and 3, there are illustrated several surfaces that advantageously are machined to tight tolerances. One such surface is the mating surface 207 of flange 205 (i.e., the flanges 305a and 305b of the respective halves that form the volute body) where the flange 205 is connected to other components. Other examples of surfaces that are advantageously machined are the surfaces that form the shaft hole 209 in impeller 201 and in which the motor shaft 205 engages the impeller 201.

The divider plate 204 and the impeller vanes 211 experience the most aggressive abrasion or wear from the abrasive slurry moved through the pump. Therefore, these portions of the centrifugal pump 107 are advantageously manufactured from a material that is highly resistant to wear. The portions of the centrifugal pump 107 that are advantageously machined to tight tolerances and the portions that are advantageously manufactured from a wear-resistant material are not coincident. Consider for example the impeller 201. The material that should be machined to form a precise hole for the shaft 205 is located immediately adjacent to that hole. The vanes 211, on the other hand, are located distally from the area adjacent to the shaft hole. Therefore it is possible to manufacture the portion of the impeller 201 adjacent to the shaft hole from a first material that is readily machined and the portion of the impeller consisting of the vanes 211 from a second material that is wear-resistant.

Therefore, the flange 205 on the volute 203 and the cylinder 213 that includes the inner surface 209 of the bore hole for the shaft 205 are cast from a first material that is suitable for machining, for example, mild steel. The portions of the pump 107 that are exposed to the abrasive slurry, e.g., the vanes 211, the divider plate 204, and the chamber portions of the volute are cast from a second material, for example, white iron. After heat treating the parts that make up the centrifugal pump 107, only the portions manufactured from the first material are machined.

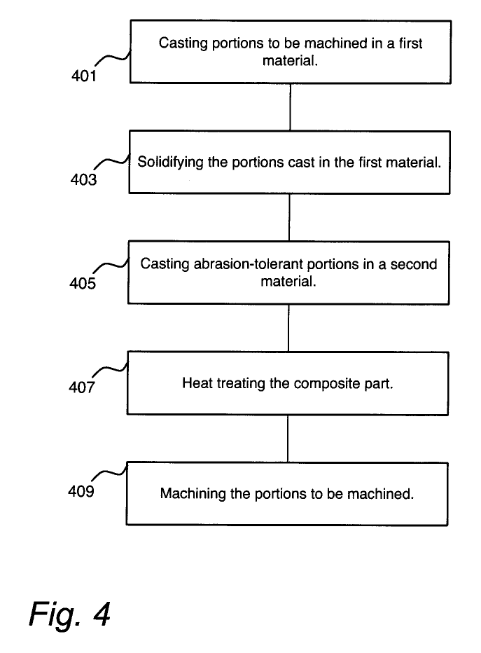

FIG. 4 is a work-flow diagram illustrating the manufacturing method for producing a composite part having portions manufactured in a wear-resistant material and portions manufactured in machinable material. It should again be noted that wear-resistance and machinability are properties provided here for purposes of illustration. The two-stage casting method as described herein to obtain a composite part with portions having a first property and portions having a second property is applicable to other properties and materials having those properties.

The portions to be machined are cast in a first material, step 401. This step includes the substeps of determining the volume of first material required, positioning the mold such that the casting liquid, e.g., molten mild steel, pours into the portions of the mold that correspond to the portions of the composite part that include the surfaces to be machined.

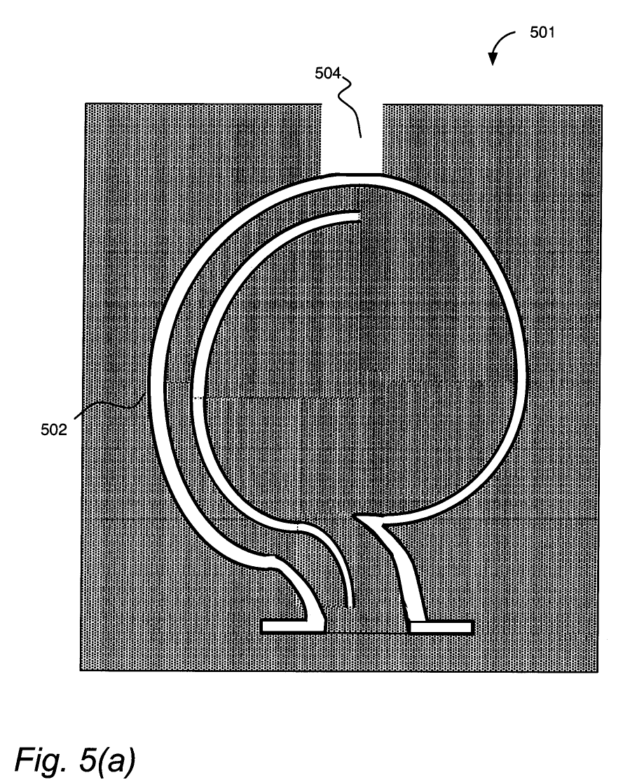

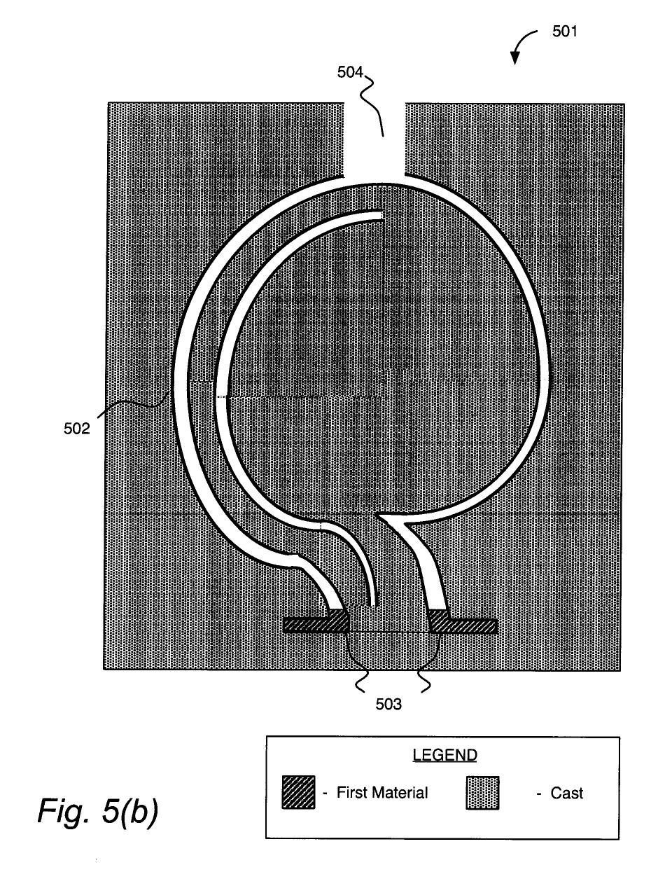

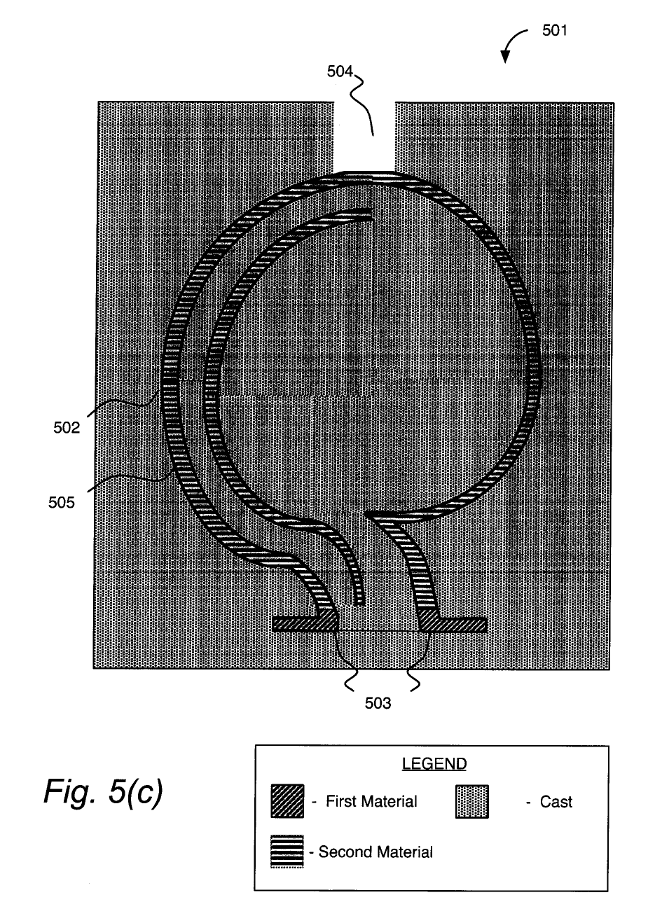

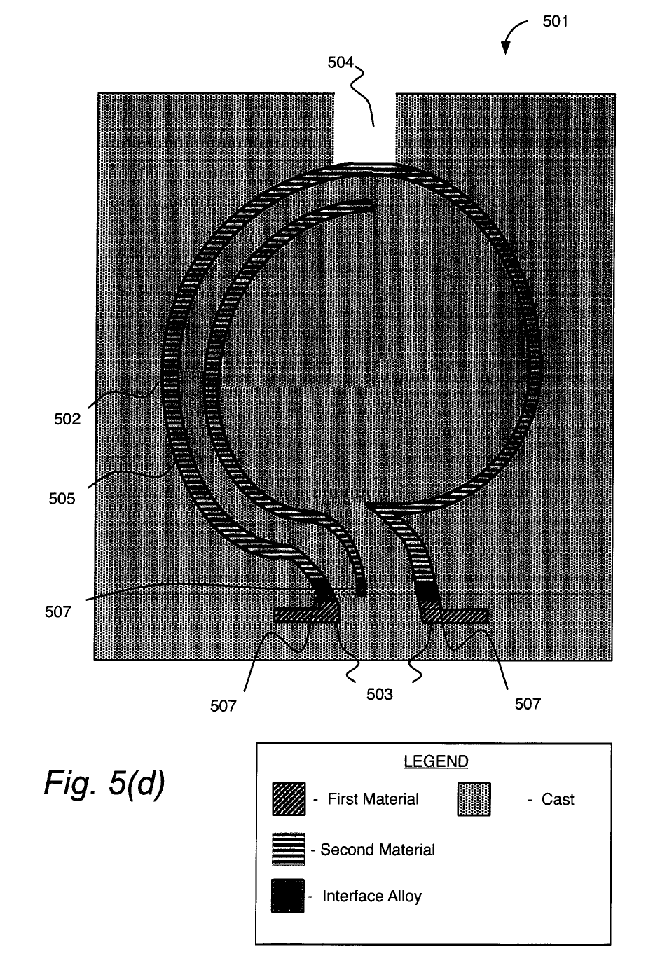

FIG. 5(a) is a cross-section of a mold 501 for casting the volute body 301(b). The mold 501 consists of a cavity 502 into which molten material may be poured through an opening 504. In the illustration of FIG. 5(a), the mold 501 is empty as it would be prior to the first casting step 401. FIG. 5(b) illustrates the mold 501 in the same cross-section after the first material 503 has been poured into the mold 501, namely the material to form the flange portion 205.

The portions cast in a first material are allowed to solidify to the point it is advantageous to pour the second metal into the mold, step 403. The extent of solidification desired in the first material may be material or process dependent. For example, it may be desirable that the first material remains partially molten or near its melting point to obtain a desirable interface between the first and second material as may be obtained through metallic high-temperature interdiffusion or a similar bonding process that occurs more expeditiously at elevated temperatures.

Next, the wear-resistant portions are cast in a second material, step 405. FIG. 5(c) is a cross-section of the mold 501 after the second material 505 has been poured into the mold 501. FIG. 5(d) is a cross-section illustrating an alternative embodiment in which the first material and second material are selected such that a certain amount of interface alloying 507 occurs, for example, by the second material melting and mixing with the first material.

To obtain the desired hardness of the wear-resistant portions of the composite part, the part is heat-treated, step 407.

To obtain the desired machined surfaces for mating the composite part to other pieces of equipment, those surfaces, which are located on portions of the composite part cast in the first material, are machined, step 409.

In an embodiment, the first material, i.e., the material used to cast portions that are to be machined, is mild steel. Mild steel is a metal alloy that is a combination of iron and carbon. In an embodiment, the carbon content of the mild steel is.in the range of about 0.25 to about 0.3% such as steel defined by ASTM A27 “Specification for Steel Casings, Carbon, for General Application”, ASTM International, 1991, pp. 1-3, or as subsequently modified, (the entire contents of which is incorporated herein by reference). An alternative material is steel defined by ASTM A148 “Specification for Steel Casings, High Strength, for Structural Purposes, ASTM International, 1993, pp. 82-84, or as subsequently modified, (the entire contents of which is incorporated herein by reference) which is a specification for high-strength steel castings and which limits sulphur and phosphorous additives. Yet other alternative materials that have a desirable machinability include aluminum and brass. Other materials having a desirable machinability may also be used. There are many factors affecting “machinability” and no universally agreed method to quantify it. However, an ancillary property is fracture toughness. Fracture toughness is the stress intensity factor at which a crack initiated in a material will propagate in the material and lead to a fracture of the material. Machining a material tends to place stress on a material in a manner that tends to cause minute cracks (which are common in most solids) to propagate. One measure of fracture toughness is the Charpy impact test (also known as the Charpy v-notch test) defined in the ASTM A370 “Standard Test Methods and Definitions for Materials Testing of Steel Products,”, ASTM International, May 2005, pages 17-23, or as subsequently modified, (the entire contents of which is incorporated herein by reference). In an embodiment, the fracture toughness of the first material is at least equal to the fracture toughness of 14 ft-lbf according to the Charpy impact test. Another way to measure fracture toughness is as a comparison to a reference material. In an embodiment, the fracture toughness is at least equal to that of steel with a carbon content of about 0.3%.

In an embodiment, the second material, i.e., the material used to cast the wear-resistant portions of the composite part, is, for example, Class III cast iron defined by ASTM A532 “Specification for Abrasion-Resistent Cast Irons”, ASTM International, 1993, p. 292-293, or as subsequently modified, (the entire contents of which is incorporated herein by reference). Class III cast iron is an iron alloy that contains between about 2.0 and about 3.7 percent carbon and about 23-30% chromium, part of which is united, as a carbide, with a portion of the iron in the alloy. More generally, an alternative material for the second material, i.e., the material for casting of the wear-resistant portions is any metal alloy that satisfies any class of the A532 standard. Yet more generally, an alternative material for the second material, i.e., the material for casting the wear-resistant portions is a white iron, wherein a white iron is defined as an iron alloy that contains between 2 and 4 percent carbon and at least 23 percent chromium. White iron, e.g., ASTM A532 Class III cast iron, has considerable resistance to abrasion due to a surface carbide formed by significant chromium alloying.

In alternative embodiments, other metals or metal alloys may be used for the second material, i.e., the wear-resistant material. In an embodiment, the wear-coefficient of the second material should be no worse than white iron with a chromium content of 23 percent.

Hardness may also be measured on the Brinell hardness scale, which is defined by ASTM E10 “Test Method for Brinell Hardness of Metallic Materials”, ASTM International, June 2007, pages 1-4, or as subsequently modified, (the entire contents of which is incorporated herein by reference). The hardness of the second material, i.e., the wear-resistant material should have a Brinell hardness number (Bhn) of at least about 400 Bhn.

Unfortunately, while very abrasion resistant, Class III cast iron and other white irons have very low fracture toughness and are therefore not readily machined.

In an alternative view of the relationship between the two desirable properties, the first material should have a fracture toughness that is greater than the fracture toughness of the second material. Conversely, the second material should have a wear-coefficient that is greater than the wear-coefficient of the first material, i.e., the second material should be more wear resistant than the first material.

In certain applications of the aforementioned two-stage casting method for producing a composite part the first material has a melting point that is higher than the melting point of the second material. In the embodiment of the mild steel/white iron composite described above, the mild steel (depending on precise composition) has a melting point of approximately 2750 degrees Fahrenheit and the white iron (also depending on precise composition) has a melting point of approximately 2300 degrees Fahrenheit. With the first material having a melting point that is higher, the pouring of the molten second material on the solidified first material is insufficient to melt the first material and thereby causing undesirable alloying that may defeat the sought-after property, i.e., in the case of the mild steel, machinability.

In an embodiment, as described above in conjunction with FIG. 5(d), interface alloying is obtained by having the second material having a higher melting point than the first material. If the heat content of the poured second material is less than the heat necessary to melt the solidified first material, only a portion of the first material would melt even if the melting point of the first material is lower than the temperature of the poured second material.

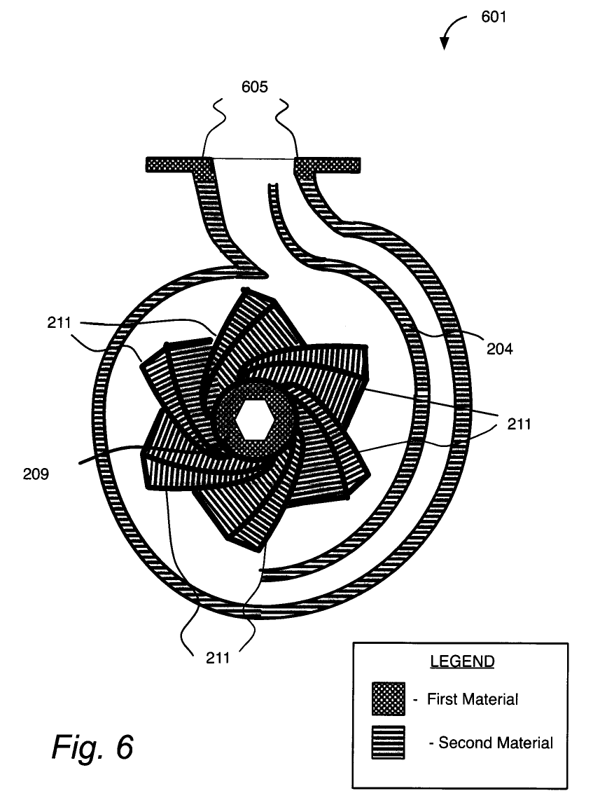

FIG. 6 is a cross-section of a centrifugal pump 601 manufactured according to the manufacturing method described herein above. The cylinder of material 209 adjacent to the shaft bore hole of the impeller and the volume of material 605 containing the flange are both made from a first material, e.g., mild steel, and the other portions, including portions subjected to wear from the abrasive slurry, for example, the impeller vanes 211 and the divider 204, are manufactured from a second material, e.g., white iron. The first material selected for the volute body and the first material selected for the impeller are not necessarily the same as these parts are cast separately. Similarly, the second material used in the volute body and the second material used in the impeller also are not necessarily the same.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. In particular, every range of values (of the form, “from about A to about B,” or, equivalently, “from approximately A to B,” or, equivalently, “from approximately A-B”) disclosed herein is to be understood as referring to the power set (the set of all subsets) of the respective range of values. Accordingly, the protection sought herein is as set forth in the claims below.

We claim:

1. A method of casting a composite component of an apparatus for handling abrasive fluids, the component having portions that are machined and portions that are wear-resistant, comprising:
casting portions to be machined in a first material; and
casting wear-resistant portions in a second material.

2. The method of claim 1, further comprising:
solidifying the portions cast in the first material prior to casting the portions that are cast in a second material.

3. The method of claim 2, further comprising:
heat-treating the composite component.

4. The method of claim 1, further comprising:
machining the portions to be machined to have a mating surface for assembling the component into the apparatus or for attaching the apparatus to external fluid handling equipment.

5. The method of casting a composite component according to claim 1 wherein the first material is selected from the group consisting of carbon steel with no more than about 0.3 percent carbon, mild steel having a carbon content of about 0.25 to about 0.3 percent aluminum, and brass.

6. The method of casting a composite component according to claim 1 wherein the second material is a one of white iron and a metal defined by ASTM A532.

7. The method of casting a composite component according to claim 1 wherein the first material is a metal with fracture toughness that is greater than fracture toughness of the second material.

8. The method of casting a composite component according to claim 1 wherein the second material is a metal having a hardness that is greater than the hardness of the first material.

9. The method of casting a composite component according to claim 1 wherein the second material has a Brinell hardness number of at least about 400.

10. The method of casting a composite component according to claim 1 wherein the melting point of the first material is higher than the melting point of the second material.

11. The method of casting a composite component according to claim 1 wherein the melting point of the first material is lower than the melting point of the second material and the second material cast in the step of casting the wear-resistant portions in a second material having a heat content sufficient to produce interface alloying between the portion suitable for machining and the wear-resistant portions while leaving a sufficient portion of the first material not alloyed into the portions to be machined.

12. A component of an apparatus for handling abrasive fluids, comprising:
a first portion cast from a material suitable for machining and machined to mate with other components of an apparatus for handling abrasive fluids; and
a second portion cast from a wear-resistant material and located on the component in a location exposed to abrasive fluids when the component is assembled into an apparatus for handling abrasive fluids and connected to the first portion through an interface formed by casting the second portion onto the first portion.

13. The component of an apparatus of claim 12 wherein the material suitable for machining is selected from the group consisting of carbon steel with no more than about 0.3% carbon, mild steel having a carbon content of about 0.25 percent to about 0.3 percent, aluminum, and brass.

14. The component of an apparatus of claim 12 wherein the wear-resistant material is a one of white iron and a metal defined by ASTM A532.

15. The component of an apparatus of claim 12 wherein the material suitable for machining has a fracture toughness that is greater than the fracture toughness of the wear-resistant material.

16. The component of an apparatus of claim 12 wherein the wear-resistant material has a hardness that is greater than the hardness of the material suitable for machining.

17. The component of an apparatus of claim 12 wherein the wear-resistant material has a Brinell hardness number of at least about 400.

18. The component of an apparatus of claim 12 wherein the material suitable for machining has a melting point that is higher than the melting point of the wear-resistant material.

19. The component of an apparatus of claim 12 further comprising an interface alloy portion located between the first portion and the second portion and consisting of a mixture of the first material and the second material.

20. A centrifugal pump for handling abrasive fluids, the pump comprising:
a pump body having a flange cast from a material suitable for machining and having a mating surface machined to mate with other components of an apparatus for handling abrasive fluids and exposed volute-chamber walls cast from a wear-resistant material and connected to the material suitable for machining by an interface formed by casting the wear-resistant material onto the material suitable for machining; and
an impeller having a central hub portion cast from a material suitable for machining, a central bore machined in the central hub portion and adapted to mate to a pump shaft, and vanes cast from a wear-resistant material and connected to the material suitable for machining by an interface formed by casting the wear-resistant material onto the material suitable for machining.

21. The centrifugal pump for handling abrasive fluids of claim 20 wherein the material suitable for machining is selected from the group consisting of carbon steel with no more than about 0.3% carbon, mild steel having a carbon content of about 0.25 percent to about 0.3 percent, aluminum, and brass.

22. The centrifugal pump for handling abrasive fluids of claim 20 wherein the wear-resistant material is a one of white iron and a metal defined by ASTM A532.

23. The centrifugal pump for handling abrasive fluids of claim 20 wherein the material suitable for machining has a fracture toughness that is greater than the fracture toughness of the wear-resistant material.

24. The centrifugal pump for handling abrasive fluids of claim 20 wherein the wear-resistant material has a hardness that is greater than the hardness of the material suitable for machining.

25. The centrifugal pump for handling abrasive fluids of claim 20 wherein the wear-resistant material has a Brinell hardness number of at least about 400.

26. The centrifugal pump for handling abrasive fluids of claim 20 wherein the material suitable for machining has a melting point that is higher than the melting point of the wear-resistant material.

27. The centrifugal pump for handling abrasive fluids of claim 20 further comprising an interface alloy portion located between the wear-resistant material and the material suitable for machining and consisting of a mixture of the wear-resistant material and the material suitable for machining.
